(19) United States
(12) Patent Application Publication
(10) Pub. No.: US 2009/0231486 A1
(43) Pub. Date: Sep. 17, 2009

(54) Method and Device for De-Interlacing a Video Signal Having a Field of Interlaced Scan Lines

(75) Inventor: Hung-Chi Fang, Luodong Town (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 12/047,629

(22) Filed: Mar. 13, 2008

(51) Int. Cl. H04N 7/01

(52) U.S. Cl. 348/448; 348/E07.003

(57) ABSTRACT

A method and a device for de-interlacing a video signal having a field of interlaced scan lines are provided. The device comprises a direction engine and an interpolator. The direction engine is configured to calculate a de-interlacing cost with respect to a plurality of target pixels according to a first block and a second block of a plurality of pixels in the first and second interlaced scan lines respectively along each of a plurality of predetermined directions, and determine an interpolating direction for the target pixels among the predetermined directions according to the calculated de-interlacing cost of each of the predetermined directions. The interpolator interpolates the target pixels between the first and second interlaced scan lines along the interpolating direction.

### BACKGROUND OF THE INVENTION

1. Field of the Invention

The present invention relates to a method and a device for de-interlacing a video signal, and more particularly to a method and a device for de-interlacing the video signal by individual blocks of pixels thereof.

2. Descriptions of the Related Art

It should be noted that a conventional video image is constituted, in respect of each image, by two fields, known as an even-numbered field and an odd-numbered field, which are interlaced on alternate lines. When the image is displayed, these fields are scanned successively in time on the screen, typically a cathode ray tube, with the lines of the second field of the image being scanned on the spaces left between the scanning lines of the first field. In a progressive scanning, the successive lines of a complete image are displayed sequentially. The interlaced scanning is able to double the vertical resolution while still retaining the same pass band. In addition, the interlaced scanning is able to double the frame return frequency at equal vertical resolution. Thus, the effect of flickering is well reduced by using the interlaced scanning.

Analog and digital video signals are generally formatted in the form of interlaced frames, known as “interlaced video”. It is necessary to de-interlace interlaced video signals for displaying in the progressive scanning mode. The progressive scanning mode is used particularly in addressable line-by-line display devices such as plasma panels, liquid crystal display (LCD), organic light-emitting diodes (OLEDs).

Such systems, known as “de-interlacing” systems, produce all the displayed lines of an image from only one field of the two fields of which it consists. In fact, since a field contains only one line in two lines of the image, interpolation technique is utilized to determine the content of the missing lines according to adjacent lines and where appropriate the adjacent fields.

Edge Line Average (ELA) technique is generally utilized to interpolate pixels for missing lines, wherein the existing adjacent lines are applied to find edge direction and interpolate pixels of the missing lines in a pixel-by-pixel basis. That is each pixel of the missing lines is interpolated along its own direction. Because it is required to compute a direction for each pixel of the missing lines to be interpolated, the ELA technique has some drawbacks, such as large computation, less stability, and inconsistency.

Accordingly, a de-interlacing system with less computation, better stability and consistency is desired.

### SUMMARY OF THE INVENTION

One objective of this invention is to provide a method for de-interlacing a video signal having a field of interlaced scan lines. The method comprises the following steps: calculating a de-interlacing cost with respect to a plurality of target pixels according to a first block and a second block of a plurality of pixels in first and second interlaced scan lines respectively along each of a plurality of predetermined directions; determining an interpolating direction for the target pixels among the predetermined directions according to the calculated de-interlacing cost of each of the predetermined directions; and interpolating the target pixels between the first and second interlaced scan lines along the interpolating direction.

Another objective of this invention is to provide a device for de-interlacing a video signal having a field of interlaced scan lines. The device comprises a direction engine and an interpolator. The direction engine is configured to calculate a de-interlacing cost with respect to a plurality of target pixels according to a first block and a second block of a plurality of pixels in first and second interlaced scan lines respectively along each of a plurality of predetermined directions, and determine an interpolating direction for the target pixels among the predetermined directions according to the calculated de-interlacing cost of each of the predetermined directions. The interpolator interpolates the target pixels between the first and second interlaced scan lines along the interpolating direction.

To achieve these objectives, the present invention de-interlaces a field of interlaced scan lines in a block manner; that is, a block of the target pixels to be interpolated between the interlaced scan lines is computed and interpolated along one direction. Accordingly, the computation for de-interlacing the field of interlaced scan lines can be reduced and stability and consistency of de-interlaced images are improved at the same time.

The detailed technology and preferred embodiments implemented for the subject invention are described in the following paragraphs accompanying the appended drawings for people skilled in the art to well appreciate the features of the claimed invention.

### BRIEF DESCRIPTION OF THE DRAWINGS

FIG. 1 is a schematic diagram illustrating a de-interlacing device of a first embodiment of the present invention;

FIG. 2a˜FIG. 2e are schematic diagrams illustrating interpolating pixels of a de-interlace line along different predetermined directions; and

FIG. 3 is a flow chart of a method for de-interlacing a video signal according to a second embodiment of the present invention.

### DESCRIPTION OF THE PREFERRED EMBODIMENT

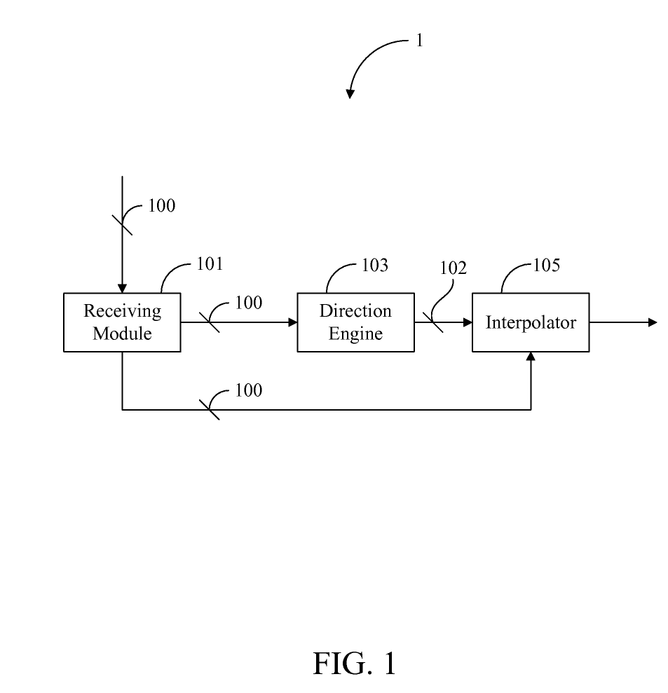

A first embodiment of the present invention is a de-interlacing device 1 for de-interlacing a video signal having a field of interlaced scan lines. Each interlaced scan line has a plurality of pixels. The de-interlacing device 1 is illustrated in FIG. 1, which comprises a receiving module 101, a direction engine 103, and an interpolator 105.

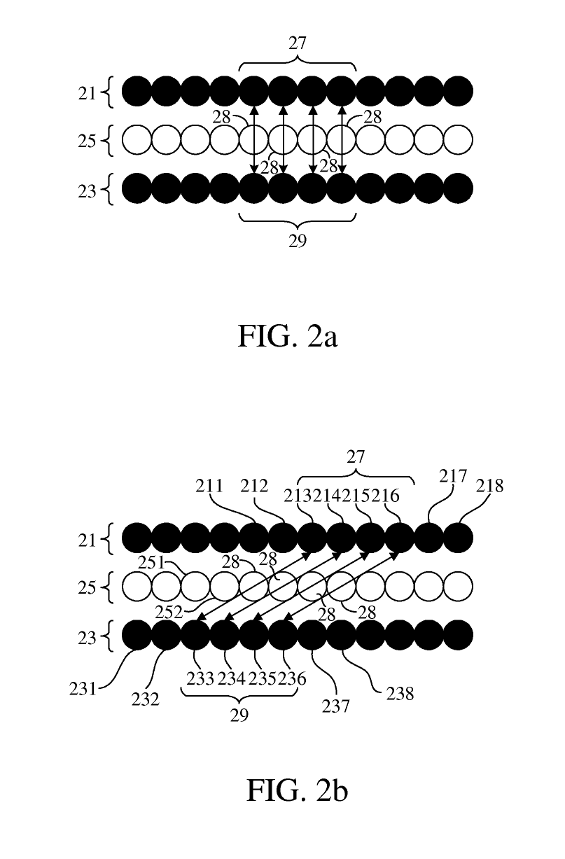

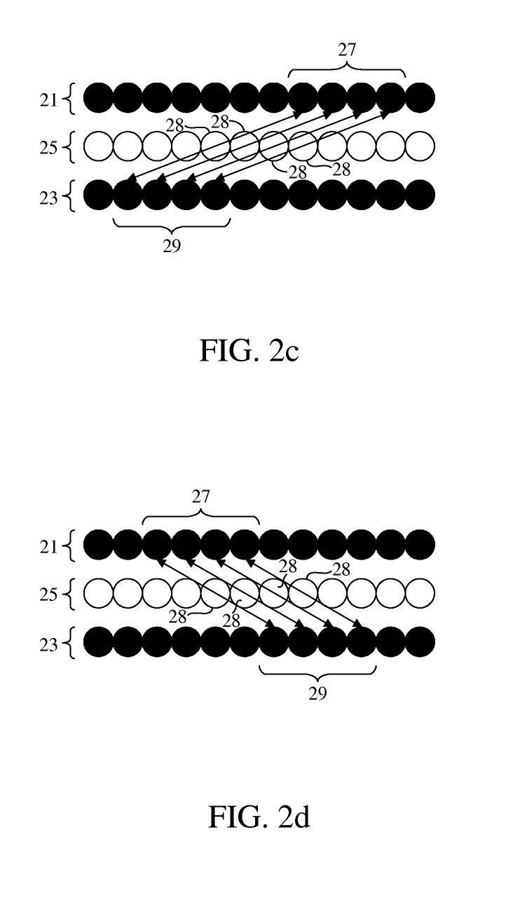

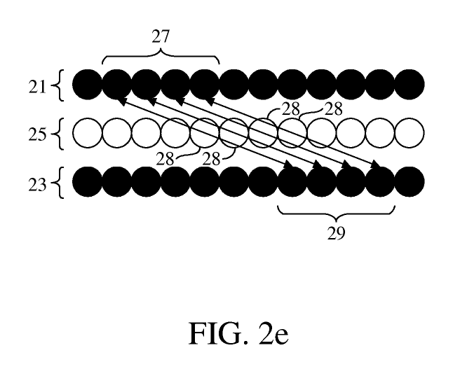

The receiving module 101 is configured to receive the video signal 100. The interlaced scan lines of the video signal 100 are illustrated in FIGS. 2a˜2e. There are only two interlaced scan lines 21, 23 illustrated in FIGS. 2a˜2e, and the interlaced scan lines will be denoted hereinafter as the first interlaced scan line 21 and the second interlaced scan line 23. Both the first and second interlaced scan lines 21, 23 have a plurality of pixels. A de-interlaced line 25 having a plurality of target pixels is generated according to the first interlaced scan line 21 and the second interlaced scan line 23, and interpolated between the first and second interlaced scan lines 21, and 23.

Before the de-interlaced line 25 is interpolated, the direction engine 103 decides a number of the pixels in a first block of the first interlaced scan line and a number of the pixels in a second block of the second interlaced scan line. The numbers of the pixels in the first block and the second block may be the same and may be different. In the embodiments of the invention described in the following, both the numbers of the pixels in the first and second blocks are set to be four. Since the de-interlacing device 1 will process in various predetermined directions, there are respective first block and second block for each of the predetermined directions, which are shown in FIGS. 2a˜2e.

Once the numbers of the pixels in the first block and second block have been decided, the direction engine 103 interpolates four pixels of the de-interlaced line 25 according to the first block and the second block along each of the predetermined direction to derive a plurality of temporary de-interlaced results. Target pixels 28 of the de-interlaced line 25 and the corresponding first block 27 and second block 29 along different predetermined directions represented by the arrows are illustrated in FIG. 2a˜FIG. 2e. For example, in the predetermined direction (diagonal direction at +45°∘) represented by the arrow shown in FIG. 2b, the corresponding first block 27 in the first interlaced scan line 21 for the target pixels 28 includes pixels 213, 214, 215, and 216, and the corresponding second block 29 in the second interlaced scan line 23 includes pixels 233, 234, 235, and 236. It is noted that the predetermined direction is not limited to the directions shown in FIGS. 2a˜2e, and designers may adjust it according to design necessity. This is known in the art and thus not further described.

The direction engine 103 calculates a de-interlacing cost for the target pixels 28 according to the first block 27, and the second block 29 along each of the predetermined directions.

More specifically, the de-interlacing cost comprises three kinds of costs, such as a neighbor cost, an internal cost, and a continuity cost. It means that the direction engine 103 respectively computes the neighbor cost, the internal cost, and the continuity cost for the target pixels 28 according to the corresponding pixels of the first interlaced scan line 21 and the second interlaced scan line 23, and previously interpolated pixels. The neighbor cost corresponds to pixel value differences between at least one pixel in the first interlaced scan line 21 and neighboring to the first block 27 and at least one pixel in the second interlaced scan line 23 and neighboring to the second block 29. The internal cost corresponds to pixel value differences between pixels in the first block 27 and pixels in the second block 29. The continuity cost is computed between at least one previously interpolated pixel neighboring to the target pixels in the de-interlaced line 25 and at least one pixel in the first interlaced scan line 21 and neighboring to the first block, and/or computed between at least one previously interpolated pixel neighboring to the target pixels in the de-interlaced line 25 and at least one pixel in the second interlaced scan line 23.

A more concrete example is given here. In FIG. 2b, the direction engine 103 computes square differences between each corresponding pixels in the first block 27 and the second block 29 to derive the internal cost with respect to the target pixels 28 along each of a plurality of predetermined directions. For example, the direction engine 103 computes a first square difference between the pixel 213 and the pixel 233, a second square difference between the pixel 214 and the pixel 234, a third square difference between the pixel 215 and the pixel 235, and a fourth square difference between the pixel 216 and the pixel 236. It is noted that the internal cost of this example is computed along a diagonal direction at +45°, which is represented by the arrow in FIG. 2b. The internal cost with respect to the target pixels 28 along the +45°∘ diagonal direction is then derived with the direction engine 103 by summing up the first, second, third and fourth square differences.

The direction engine 103 then computes square differences between the pixels in the first interlaced scan line 21 and neighboring to the first block 27 and the pixels in the second interlaced scan line 23 and neighboring to the second block 29 to derive the neighbor cost with respect to the target pixel 28. For example, the direction engine 103 computes a first square difference between the pixel 211 and the pixel 231, a second square difference between the pixel 212 and the pixel 232, a third square difference between the pixel 217 and the pixel 237, and a fourth square difference between the pixel 218 and the pixel 238. The neighbor cost with respect to the target pixels 28 along the +45°∘ diagonal direction is then derived by the direction engine 103 by summing up the computed square differences This invention is not limited by the number of the square differences which are computed to derive the neighbor cost. That is, the direction engine 103 may compute different number of the square differences for respective pixels neighboring to the first block 27 and second block 29, e.g. 2 or 6 square differences to derive the neighbor cost. Those skilled in the art are able to realize operations and functions of embodiments considering different number of neighboring pixels to derive the neighbor cost based on the above descriptions. Therefore, the descriptions therefor are not repeated herein.

The direction engine 103 proceeds to compute square differences between the pixels in the first interlaced scan line 21 neighboring to the first block 27 and previously interpolated pixels neighboring to the target pixels 28 in the de-interlaced line 25, or the pixels in the second interlaced scan line 23 neighboring to the second block 29 and previously interpolated pixels along a plurality of each of a plurality of predetermined directions to derive the continuity cost. For example, the direction engine 103 computes a first square difference between the pixel 211 and the pixel 251, a second square difference between the pixel 212 and the pixel 252. The direction engine 103 then sums up the square differences to derive the continuity cost with respect to the target pixels 28 along the +45°∘ diagonal direction. Alternatively, the direction engine 103 may be adapted to compute square differences between the pixels in the second interlaced scan line 23 and neighboring to the second block 29 and previously interpolated pixels neighboring to the target pixels 28 in the de-interlaced line 25. For example, the direction engine 103 is adapted to compute a first square difference between the pixel 231 and the pixel 251 and a second square difference between the pixel 232 and the pixel 252, and sum up the square differences to derive the continuity cost. Moreover, the direction engine 103 is capable of summing up the four square differences which are described above to derive the continuity cost. This invention is not limited by the number of the square differences which are computed to derive the continuity cost. Those skilled in the art are able to realize operations and functions of embodiments considering different number of square differences to derive the continuity cost based on the above descriptions. Therefore, the descriptions therefor are not repeated herein

After the costs with respect to the target pixels 28, such as the internal cost, the neighboring cost, and the continuity costs. have been computed, the direction engine 103 sums up the neighbor cost, the internal cost and the continuity cost to derive a de-interlacing cost for the target pixels 28 along one of the predetermined directions such as the +45°∘ diagonal direction shown in FIG. 2b. The direction engine 103 proceeds to calculate another de-interlacing cost for the target pixels 28 along another predetermined direction. It should be appreciated by those skilled in the art that adjustment of the number and type of costs of the de-interlacing cost in accordance with desired functions is applicable within the disclosure.

When the de-interlacing cost for the target pixels 28 along each of the predetermined directions has been computed, the direction engine 103 derives a minimum de-interlacing cost thereamong, and accordingly determines an interpolating direction 102 corresponding to the minimum de-interlacing cost for the target pixels 28. The interpolator 105 computes a plurality of pixels values for the target pixels 28 in the de-interlace line 25 according to the first block 27 and the second block 29 respectively in interlaced scan lines 21, 23 of the video signal 100 along the interpolating direction 102. Finally, the interpolator 105 interpolates the target pixels having the computed pixel values between the first and second interlaced scan lines 21 and 23.

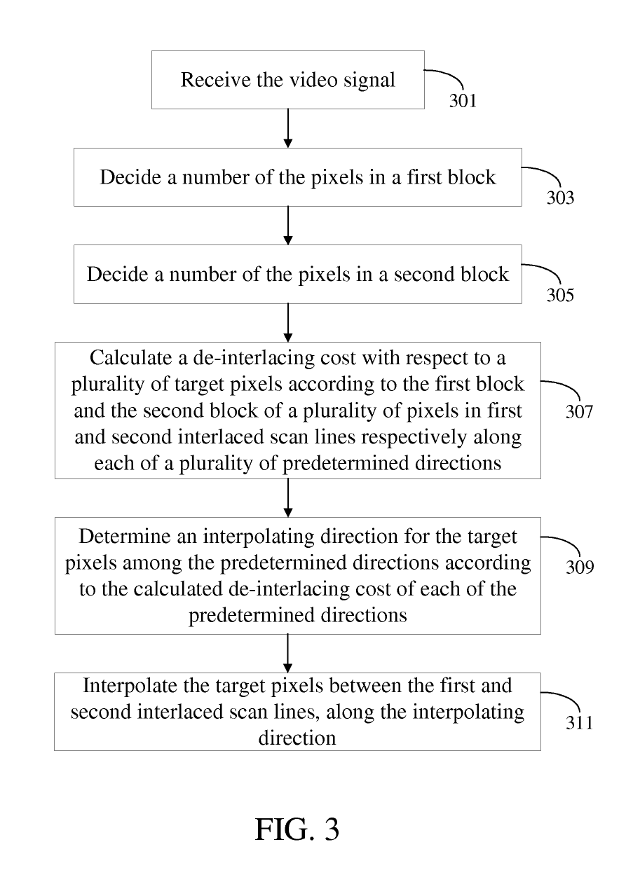

A second embodiment of the invention provides a method for de-interlacing a video signal having a field of interlaced scan lines. Each interlaced scan line has a plurality of pixels. The method applied to a device, such as the de-interlacing device 1, is as described in the first embodiment. The corresponding flow chart is shown in FIG. 3.

First, step 301 is executed for receiving the video signal. Step 303 is executed for deciding a number of the pixels in a first block. And Step 305 is executed for deciding a number of the pixels in a second block, wherein the number of the pixels in the first block and the number of the pixels in the second block may be the same. Step 307 is executed for calculating a de-interlacing cost with respect to a plurality of target pixels according to the first block and the second block of a plurality of pixels in first and second interlaced scan lines respectively along each of a plurality of predetermined directions. Then step 309 is executed for determining an interpolating direction for the target pixels among the predetermined directions according to the calculated de-interlacing cost of each of the predetermined directions. Step 311 is executed for interpolating the target pixels between the first and second interlaced scan lines, along the interpolating direction.

In addition to the steps shown in FIG. 3, the second embodiment is also capable of executing all the operations of the first embodiment. Those skilled in the art can understand the corresponding steps and operations of the second embodiment based on the above descriptions of the first embodiment, and thus the operations are not described in further detail.

According to the aforementioned descriptions, the present invention provides a new method and device for de-interlacing a field of interlaced scan lines in a block manner. That is an interpolating direction for a block of a plurality of pixels is determined, and the block of the pixels to be interpolated between the interlaced scan lines is then computed and interpolated along the interpolating direction. Accordingly, the computation for de-interlacing the field of interlaced scan lines can be reduced and stability and consistency of de-interlaced images are improved at the same time.

The above disclosure is related to the detailed technical contents and inventive features thereof. People skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for de-interlacing a video signal having a field of interlaced scan lines, comprising the steps of:
calculating a de-interlacing cost with respect to a plurality of target pixels according to a first block and a second block of a plurality of pixels in first and second interlaced scan lines respectively along each of a plurality of predetermined directions;
determining an interpolating direction for the target pixels among the predetermined directions according to the calculated de-interlacing cost of each of the predetermined directions; and
interpolating the target pixels between the first and second interlaced scan lines along the interpolating direction.

2. The method as claimed in claim 1, wherein the calculating step calculates a plurality of square differences of pixels and the method further comprises the step of:
summing up the square differences to derive the de-interlacing cost for each of the predetermined directions.

3. The method as claimed in claim 1, further comprising the steps of:
receiving the video signal;
deciding a number of the pixels in the first block; and
deciding a number of the pixels in the second block.

4. The method as claimed in claim 3, wherein the number of the pixels in the first block equals to the number of the pixels in the second block.

5. The method as claimed in claim 1, wherein the de-interlacing cost comprises an internal cost corresponding to pixel value differences between the pixels in the first block and the pixels in the second block.

6. The method as claimed in claim 1, wherein the de-interlacing cost comprises a neighbor cost corresponding to pixel value differences between at least one pixel in the first interlaced scan line and neighboring to the first block and at least one pixel in the second interlaced scan line and neighboring to the second block.

7. The method as claimed in claim 1, wherein the de-interlacing cost comprises a continuity cost between at least one previously interpolated pixel neighboring to the target pixels and at least one pixel in the first interlaced scan line and neighboring to the first block.

8. The method as claimed in claim 1, wherein the de-interlacing cost comprises a continuity cost between at least one previously interpolated pixel neighboring to the target pixels and at least one pixel in the second interlaced scan line and neighboring to the second block.

9. The method as claimed in claim 1, wherein the interpolating step comprises the steps of:
computing a plurality of pixel values for the target pixels according to the first and second blocks of the pixels in the first and second interlaced scan lines along the interpolating direction; and
interpolating the target pixels having the computed pixel values between the first and second interlaced scan lines.

10. The method as claimed in claim 1, wherein the interpolating direction corresponds to a minimum de-interlacing cost among the de-interlacing cost of each of the predetermined directions.

11. A device for de-interlacing a video signal having a field of interlaced scan lines, the device comprising:
a direction engine for calculating a de-interlacing cost with respect to a plurality of target pixels according to a first block and a second block of a plurality of pixels in first and second interlaced scan lines respectively along each of a plurality of predetermined directions and determining an interpolating direction for the target pixels among the predetermined directions according to the calculated de-interlacing cost of each of the predetermined directions; and
an interpolator for interpolating the target pixels between the first and second interlaced scan lines along the interpolating direction.

12. The device as claimed in claim 11, wherein the direction engine calculates a plurality of square differences of pixels, and the direction engine further sums up the square differences to derive the de-interlacing cost for each of the predetermined directions.

13. The device as claimed in claim 11, further comprising a receiving module for receiving the video signal, wherein the direction engine decides a number of pixels in the first block and a number of pixels in the second block.

14. The device as claimed in claim 13, wherein the number of the pixels in the first block equals to the number of the pixels in the second block.

15. The device as claimed in claim 11, wherein the de-interlacing cost comprise an internal cost corresponding to pixel differences between the pixels in the first block and the pixels in the second block.

16. The device as claimed in claim 11, wherein the de-interlacing cost comprise a neighbor cost corresponding to pixel differences between at least one pixel in the first interlaced scan line and neighboring to the first block and at least one pixel in the second interlaced scan line and neighboring to the second block.

17. The device as claimed in claim 11, wherein the de-interlacing cost comprises a continuity cost corresponding to pixel differences between at least one previously interpolated pixel neighboring to the target pixels and at least one pixel in the first interlaced scan line and neighboring to the first block.

18. The device as claimed in claim 11, wherein the de-interlacing cost comprises a continuity cost corresponding to pixel differences between at least one previously interpolated pixel neighboring to the target pixels and at least one pixel in the second interlaced scan line and neighboring to the second block.

19. The device as claimed in claim 11, wherein the interpolator further computes a plurality of pixel values for the target pixels according to the first and second blocks of the pixels in the first and second interlaced scan lines along the interpolating direction and interpolates the target pixels having the computed pixel values between the first and second interlaced scan lines.

20. The device as claimed in claim 11, wherein the interpolating direction corresponds to a minimum de-interlacing cost among the de-interlacing cost of each of the predetermined directions.
